(19) United States
(12) Patent Application Publication
(10) Pub. No.: US 2014/0098419 A1
(43) Pub. Date: Apr. 10, 2014

(54) SHUTTER GLASSES

(71) Applicant: Sony Computer Enterainment Inc., Tokyo (JP)

(72) Inventors: Akiyoshi Morita, Kanagawa (JP); Akitoshi Yamaguchi, Saitama (JP); Ryo Fukikoshi, Saitama (JP)

(73) Assignee: Sony Computer Entertainment Inc., Tokyo (JP)

(21) Appl. No.: 14/118,348

(22) PCT Filed: May 28, 2012
(86) PCT No.: PCT/JP2012/063682

§ 371 Date: Nov. 18, 2013

(30) Foreign Application Priority Data
Jun. 3, 2011 (JP) 2011-125861

(51) Int. Cl. G02B 27/22

(52) U.S. Cl. CPC G02B 27/2264
USPC 359/464

(57) ABSTRACT

Provided are shutter eyeglasses that can have simplified internal wiring. The shutter glasses include: a circuit board to which a drive circuit adapted to drive a left eye shutter and a right eye shutter is mounted; a battery adapted to supply power to the circuit board; and a reception element adapted to receive a synchronizing signal transmitted from an image display device. The circuit board, battery, and reception element are arranged between the left eye shutter and the right eye shutter.

### TECHNICAL FIELD

The present invention relates to shutter eyeglasses used, for example, to view three-dimensional (3D) images using the frame sequential technology.

### BACKGROUND ART

In order to view a 3D image displayed using the frame sequential technology, it has been common to use liquid crystal shutter eyeglasses adapted to drive the left and right eye shutters in synchronism with such a 3D image. This type of shutter eyeglasses includes a photoreception element adapted to receive a synchronizing signal from an image display device.

### CITATION LIST

### Patent Literature

[PTL1]

JP 2011-71757A

### SUMMARY

Many of the frames of the shutter eyeglasses have wall-shaped shield sections, one on the right end and another on the left end, to prevent undesired external light from reaching the eyes of the user. With conventional shutter eyeglasses, a circuit board having a drive circuit adapted to drive the two shutters is accommodated in one of the shield sections, and a battery adapted to supply power to the circuit board is accommodated in the other shield section. This layout leads to the need to provide electric conductors along the upper or lower edges of the shutters to connect the circuit board and shutters, the circuit board and photoreception element and the circuit board and battery, resulting in a complicated structure of shutter eyeglasses.

In one mode of the present invention, shutter eyeglasses have left and right eye shutters and open or close the shutters in synchronism with an image displayed on an image display device. The shutter eyeglasses include a circuit board, battery and reception element. The circuit board has a drive circuit adapted to drive the left and right eye shutters. The battery supplies power to the circuit board. The reception element receives a synchronizing signal from the image display device. The circuit board, battery and reception element are arranged between the left and right eye shutters. This layout provides simpler wiring in the shutter eyeglasses.

### BRIEF DESCRIPTION OF DRAWINGS

[FIG. 1]

FIG. 1 is a perspective view of shutter eyeglasses according to an embodiment of the present invention.

[FIG. 2]

FIG. 2 is an exploded perspective view of the shutter eyeglasses.

[FIG. 3]

FIG. 3 is a rear view of the shutter eyeglasses.

[FIG. 4]

FIG. 4 is a cross-sectional view along line IV-IV shown in FIG. 3.

[FIG. 5]

FIG. 5 is a cross-sectional view of the shutter eyeglasses having a plane represented by line V-V as a cutting plane.

[FIG. 6]

FIG. 6 is a perspective view illustrating an image display device as seen from the front.

[FIG. 7]

FIG. 7 is a perspective view illustrating the image display device as seen from the rear.

[FIG. 8]

FIG. 8 is an exploded perspective view illustrating the connection relationship between a main body section, base and support of the image display device.

### DESCRIPTION OF EMBODIMENTS

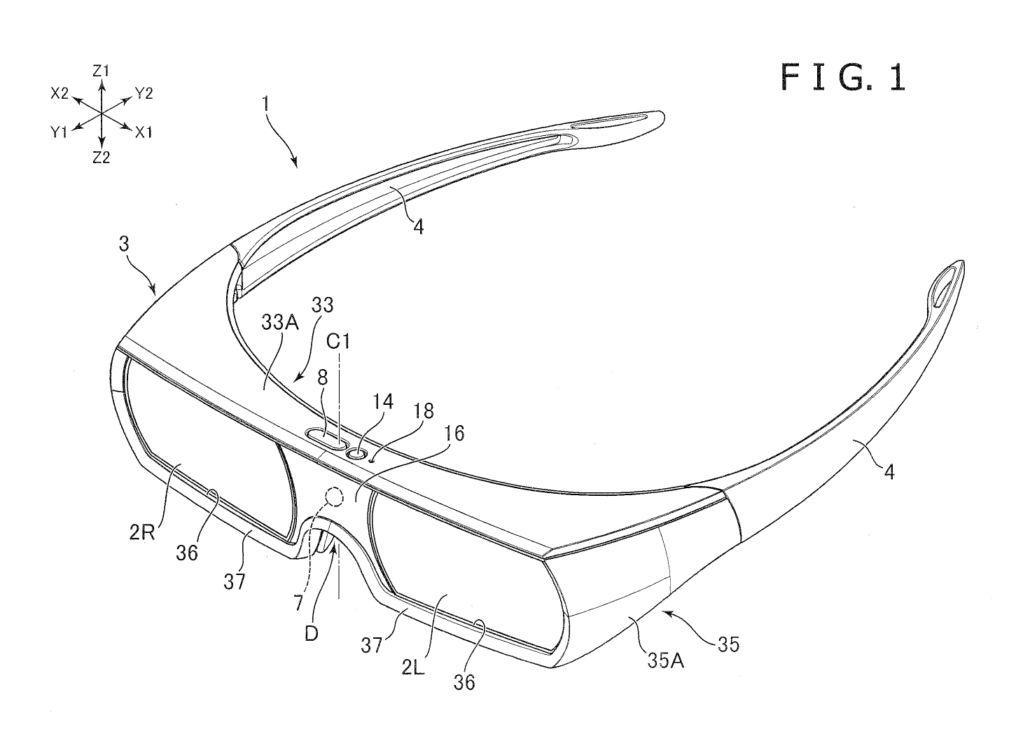

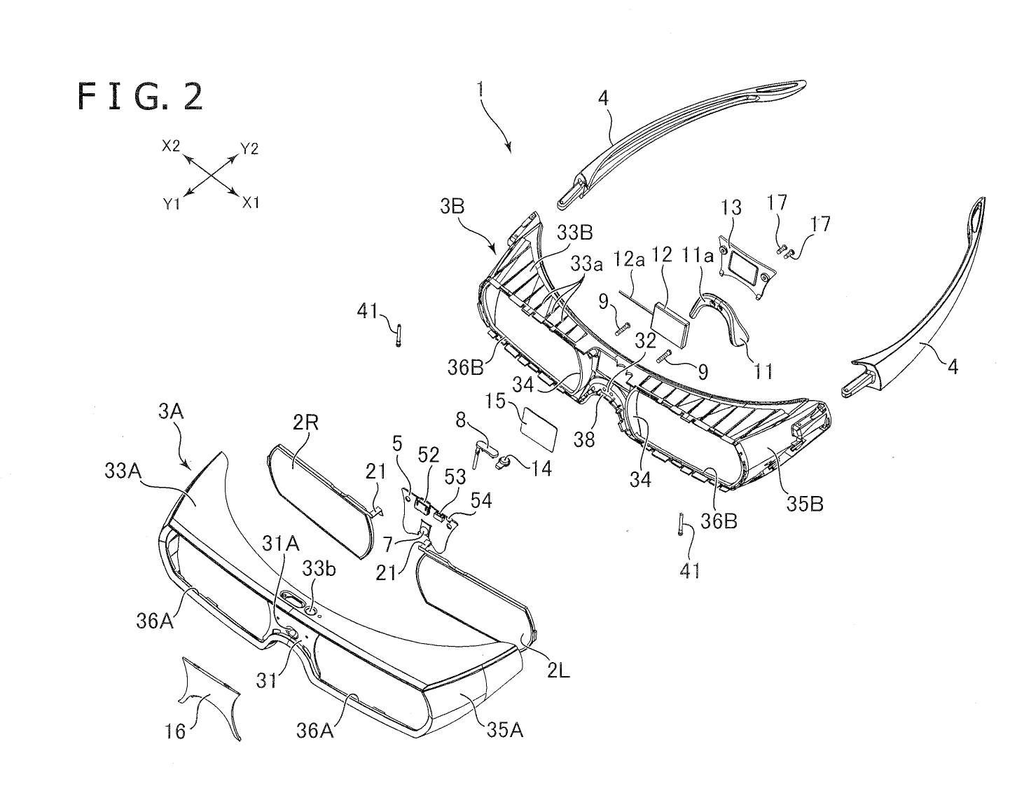

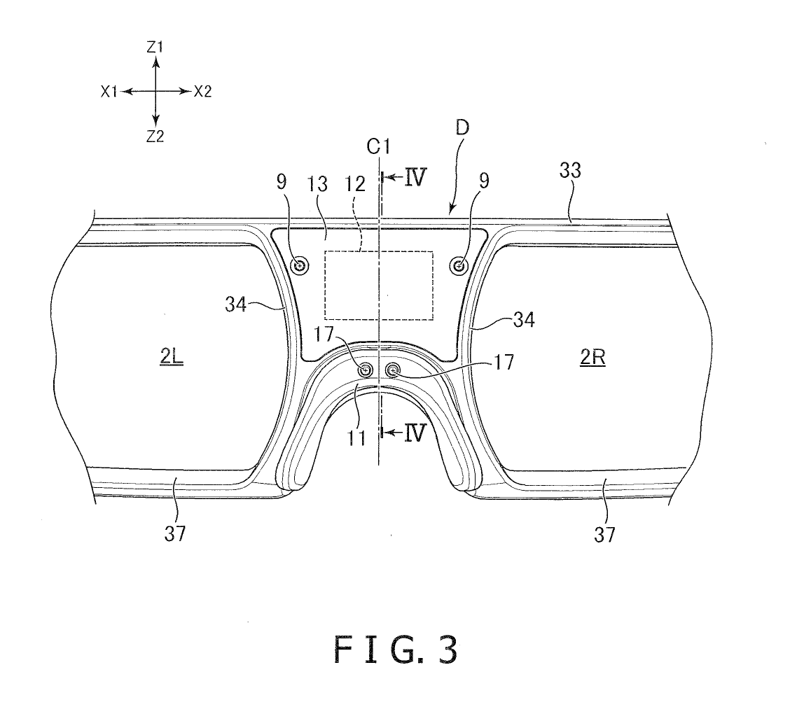

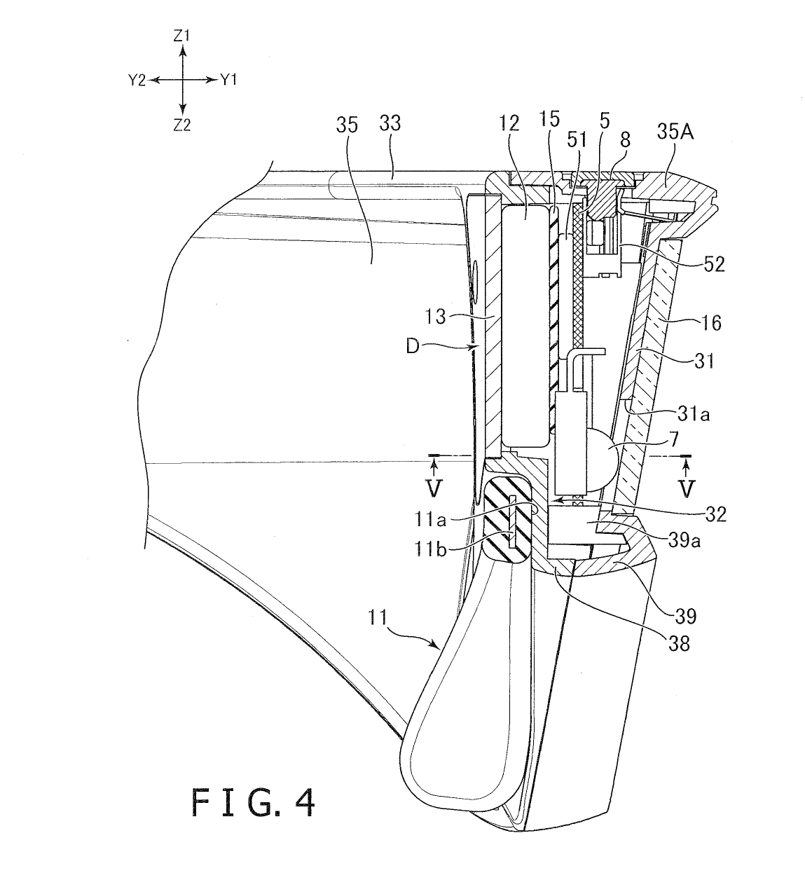

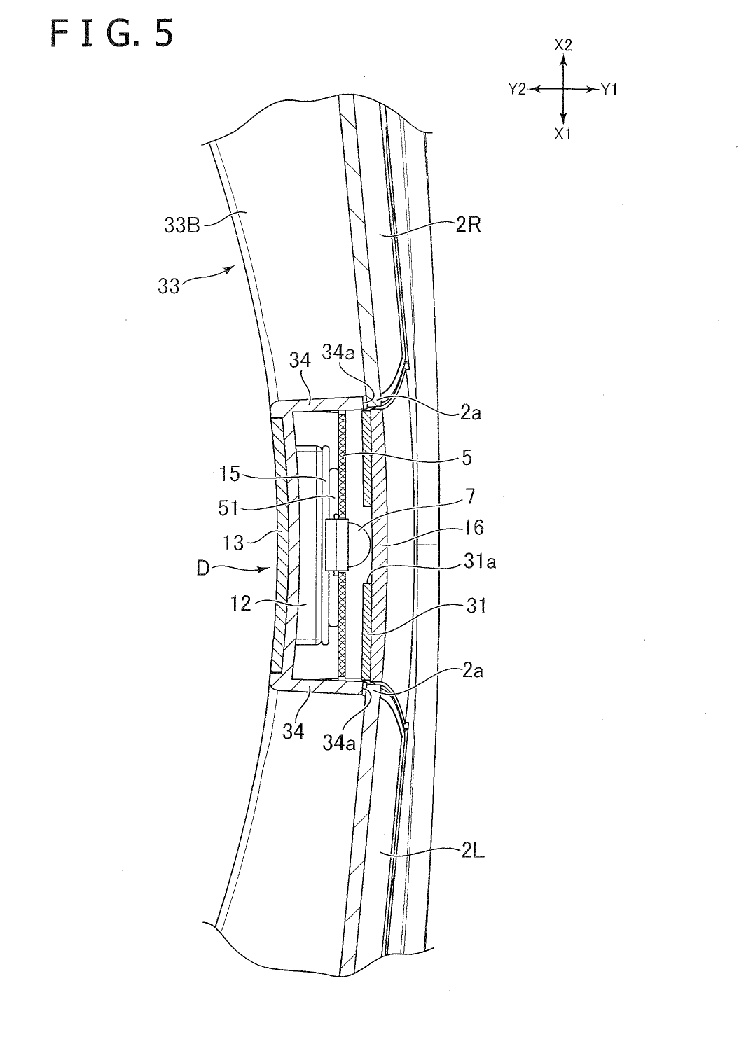

A description will be given below of an embodiment of the present invention with reference to the accompanying drawings. FIG. 1 is a perspective view of shutter eyeglasses 1 according to an embodiment of the present invention. FIG. 2 is an exploded perspective view of the shutter eyeglasses 1. FIG. 3 is a rear view of a bridge D of the shutter eyeglasses 1. FIG. 4 is a cross-sectional view along line IV-IV shown in FIG. 3. FIG. 5 is a cross-sectional view of the shutter eyeglasses 1 having a plane represented by line V-V as a cutting plane. In the description given below, the directions represented by X1 and X2 in FIG. 1 are respectively left and right, and those represented by Z1 and Z2 are respectively up and down. Further, the direction represented by Y1 and Y2 in FIG. 1 are respectively front and rear.

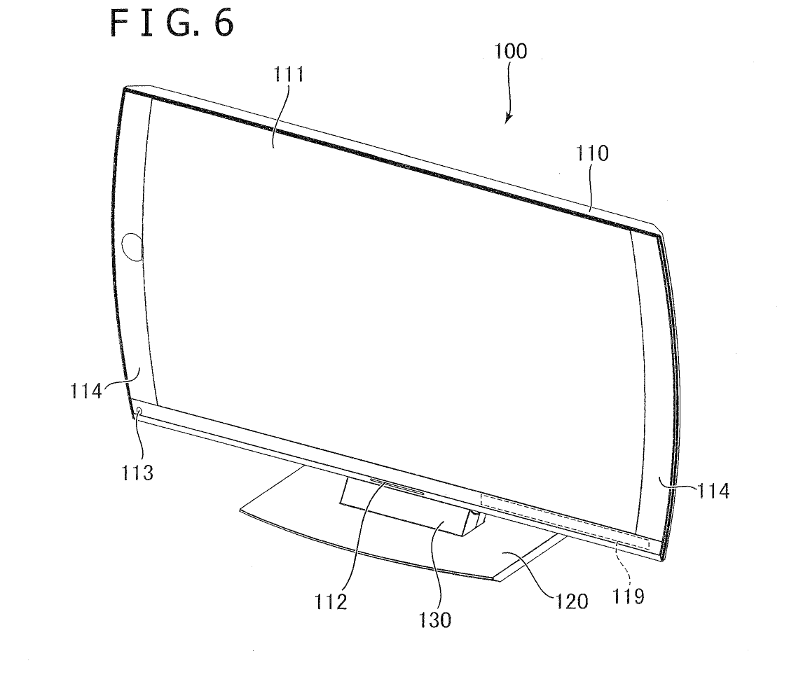

As illustrated in FIG. 1, the shutter eyeglasses 1 have right and left eye shutters 2R and 2L. Liquid crystal shutters, for example, can be used as the shutters 2R and 2L. The shutter eyeglasses 1 open or close the shutters 2R and 2L in synchronism with an image displayed, for example, on an image display device 100 (refer to FIG. 6) which will be described later. That is, the shutter eyeglasses 1 drive the liquid crystal of the shutters 2R and 2L in synchronism with an image displayed on the image display device 100, thus permitting or restricting the passage of light. If the image display device 100 displays a 3D image using the frame sequential technology, the shutter eyeglasses 1 open the shutters 2R and 2L alternately to match the timings at which the right and left eye images are displayed. On the other hand, if the image display device 100 displays different images for a plurality of users using the frame sequential technology, the shutter eyeglasses 1 open both of the shutters 2R and 2L to match the timing at which an image for the user using the shutter eyeglasses 1 is displayed. A detailed description will be given later of the image display device 100.

As illustrated in FIG. 1, the shutter eyeglasses 1 have a frame 3 adapted to hold the shutters 2R and 2L. The frame 3 has openings 36 on the right and left side portions, with the shutters 2R and 2L held respectively inside the openings 36. Further, the frame 3 has a visor-shaped upper shield section 33 that overhangs rearward from the upper edge of the shutters 2R and 2L. Still further, the frame 3 has, on the left and right end portions, wall-shaped side shield sections 35, each extending from the edge of the shutter 2R or 2L. These upper shield section 33 and side shield sections 35 block undesired external light when the shutter eyeglasses 1 are used. Still further, the frame 3 has a lower bar section 37 adapted to support the lower edges of the shutters 2R and 2L.

As illustrated in FIG. 2, the frame 3 in this example has front and rear frames 3A and 3B that are assembled together longitudinally. A lug is formed on the edge of the rear frame 3B to catch on the front frame 3A, allowing the lug to fasten the front and rear frames 3A and 3B together. With the front and rear frames 3A and 3B assembled together, the rear frame 3B is arranged on the inside of the front frame 3A. That is, the front and rear frames 3A and 3B have an outer wall section 33A and inner wall section 33B, respectively. The outer wall section 33A forms the outer face of the upper shield section 33. The inner wall section 33B forms the inner face of the upper shield section 33. A plurality of ribs 33a are formed on the upper face of the inner wall section 33B to secure the strength of the upper shield section 33. Further, the front and rear frames 3A and 3B have an outer wall section 35A and inner wall section 35B, respectively. The outer wall section 35A forms the outer face of the side shield section 35. The inner wall section 35B forms the inner face of the side shield section 35. Still further, openings 36A and 36B are formed respectively in the front and rear frames 3A and 3B, allowing the outer perimeter edges of the shutters 2R and 2L to be sandwiched between and held by the edges of the openings 36A and 36B.

As illustrated in FIG. 1, the shutter eyeglasses 1 have side arms 4 each extending rearward from one of the side shield sections 35 of the frame 3. The side arms 4 are supported by the ears of the user when the shutter eyeglasses 1 are used. The front end of each of the side arms 4 is supported by one of the side shield sections 35. In this example, the front end of each of the side arms 4 is supported through a pin 41 (refer to FIG. 2) held by one of the side shield sections 35. Each of the left and right side arms 4 can be folded inward around the pin 41.

As illustrated in FIGS. 2 and 4, the shutter eyeglasses 1 include a circuit board 5, battery 12 and reception element 7. The circuit board 5 has a drive circuit (microprocessor) 51 adapted to drive the shutters 2R and 2L. The battery 12 supplies power to the circuit board 5. The reception element 7 receives a synchronizing signal from the image display device 100. A photoreception element adapted to detect infrared radiation transmitted as a synchronizing signal from the image display device 100 can be used, for example, as the reception element 7.

As illustrated in FIGS. 3 and 4, the circuit board 5, battery 12 and reception element 7 are arranged between the two shutters 2R and 2L. That is, the frame 3 has a hollow bridge D (refer to FIG. 1) provided between the shutters 2R and 2L, with the circuit board 5, battery 12 and reception element 7 arranged inside the bridge D. This layout brings the center of gravity of the shutter eyeglasses 1 closer to a horizontal center C1 of the shutter eyeglasses 1, thus providing comfort to the user wearing the shutter eyeglasses 1. Further, this layout provides simpler wiring in the shutter eyeglasses 1. That is, electric conductors 21 (refer to FIG. 2) adapted to connect the circuit board 5 and shutters 2R and 2L can be shortened. Each of the electric conductors 21 in this example extends from the inner portion of the left or right shutter 2R or 2L, i.e., the portion closer to the horizontal center C1, to the circuit board 5. Further, this layout provides a shorter electric conductor 12a (refer to FIG. 2) adapted to connect the battery 12 and circuit board 5. Still further, the reception element 7 and circuit board 5 can be readily electrically connected. In this example, the reception element 7 is installed to the circuit board 5 in such a manner as to protrude forward from the circuit board 5.

The battery in this example is in the form of a thin rectangular parallelepiped (refer to FIG. 2). As illustrated in FIG. 4, the circuit board 5 and battery 12 are arranged in such a manner that their normals are oriented in the same direction to the shutters 2R and 2L. That is, the normals are oriented forward. The circuit board 5 and battery 12 are longitudinally side by side. This layout makes it easier to strike a horizontal weight balance of the shutter eyeglasses 1. That is, it is easier to bring the center of gravity of the shutter eyeglasses 1 close to the horizontal center C1 of the shutter eyeglasses 1. Preferably, the horizontal center of the circuit board 5 and that of the battery 12 should match the horizontal center C1 of the shutter eyeglasses 1.

As illustrated in FIG. 4, the battery 12 is located rearward of the circuit board 5. This layout allows the battery 12 to be located closer to the user when the shutter eyeglasses 1 are used, thus ensuring stability in supporting the shutter eyeglasses 1 with the nose and eyes of the user.

On the other hand, the drive circuit 51 is located on the rear side of the circuit board 5 as illustrated in FIG. 4. That is, the drive circuit 51 is installed on the face of the circuit board 5 facing the battery 12. This layout makes it easier to arrange the circuit board 5 on the front side of the bridge D, thus contributing to higher optical detection sensitivity of the reception element 7. It should be noted that, as illustrated in FIGS. 2 and 4, a sheet-shaped shock absorbing member 15 is arranged between the drive circuit 51 and battery 12.

The shutter eyeglasses 1 further have a nose pad 11 (refer to FIGS. 2 and 3) supported by the nose of the user when used. As illustrated in FIG. 4, the battery 12 is arranged above the nose pad 11, with the rear face of the battery 12 located more rearward than a front face 11a of the nose pad 11. The nose pad 11 in this example is approximately U-shaped and open downward. The battery 12 is located above the uppermost portion of the nose pad 11. This layout of the battery 12 allows the load of the battery 12 to act vertically on the user's nose via the nose pad 11, thus providing further improved stability in supporting the shutter eyeglasses 1.

As illustrated in FIG. 4, the rear frame 3B has, at the horizontal center portion, a rear lower wall section 32 adapted to define the bottom face of the space formed inside the bridge D. The rear lower wall section 32 is formed in such a manner as to be concave forward relative to a rear cover 13 which will be described later and have an L-shaped cross-section. The upper portion of the nose pad 11 is arranged inside the rear lower wall section 32 (inside the L shape) and attached to the rear lower wall section 32 by screws 17 (refer to FIG. 2). The battery 12 is located above the rear lower wall section 32.

The nose pad 11 in this example is formed with an elastic material such as elastomer. Further, the nose pad 11 has a core material 11b arranged inside the elastic material as illustrated in FIG. 4. The core material 11b is formed with a material that can be plastically deformed by the user such as wire. The user can deform the nose pad 11 to fit his or her nose.

As illustrated in FIGS. 2 and 4, the shutter eyeglasses 1 have a rear cover 13 adapted to cover the rear side of the battery 12. The same cover 13 defines the rear face of the bridge D. The battery 12 is located at the rearmost position of the space formed inside the bridge D and is in contact with the rear cover 13. In this example, the battery 12 is biased toward the circuit board 5 by the rear cover 13.

As illustrated in FIG. 2, the circuit board 5 and rear cover 13 are shaped to fit each other. The circuit board 5 and rear cover 13 are fastened to the frame 3 by common screws 9 (refer to FIG. 3). The circuit board 5 and rear cover 13 in this example are formed in such a manner that their horizontal widths increase gradually from bottom to top. Holes are formed, one at left and another at right, in the upper portions of the circuit board 5 and rear cover 13. The screws 9 are inserted into these holes.

The lower edge of the rear lower wall section 32 of the rear frame 3B is bent in such a manner as to be open downward as seen from the front as with the noise pad 11 described above. As illustrated in FIG. 4, a flange section 38 is formed in the lower edge of the rear lower wall section 32 to protrude forward. Further, the front frame 3A has, at the horizontal center portion, a front lower wall section 39 adapted to form the bottom face of the bridge D together with the flange section 38. The flange section 38 and front lower wall section 39 are also bent in such a manner as to be open downward. The circuit board 5 is located more forward than the rear lower wall section 32 described above, with the lower edge thereof located lower than the lower edge of the battery 12. The lower edge of the circuit board 5 is bent to fit the flange section 38 and front lower wall section 39. This makes it possible to increase the size of the circuit board 5 than if the same board 5 is rectangular. Bosses 39a (refer to FIG. 4) are formed in the front frame 3A. The two screws 17 are respectively inserted into the bosses 39a to fasten the nose pad 11. The lower edge of the circuit board 5 is supported by the bosses 39a, thus ensuring stable support of the circuit board 5.

The battery 12 in this example is a secondary battery. As illustrated in FIG. 2, the shutter eyeglasses 1 have a connector 52 to which electric conductors can be connected to charge the battery 12. A USB-standard connector can be, for example, used as the connector 52. The connector 52 is located between the right and left shutters 2R and 2L. In this example, the connector 52 is installed to the circuit board 5, thus eliminating the need for an electric conductor between the connector 52 and circuit board 5. The connector 52 is arranged in such a manner as to be open upward. An opening 33b is formed in the upper shield section 33 of the frame 3 (more specifically, the outer wall section 33A of the front frame 3A) to expose the connector 52. The opening 33b is closed by a connector cover 8 (refer to FIG. 1).

As illustrated in FIG. 1, the shutter eyeglasses 1 have a power button 14 located closer to the horizontal center C1 than the right and left shutters 2R and 2L. The power button 14 is provided on the upper shield section 33. By providing the power button 14 at this position, it is possible for the user to power on or off the shutter eyeglasses 1 while wearing the shutter eyeglasses 1. As illustrated in FIG. 2, a switch 53 is installed to the circuit board 5. Located below the power button 14, the switch 53 is switched on or off in response to the pressing of the power button 14. With the shutter eyeglasses 1 assembled, the power button 14, switch 53 and connector 52 are horizontally side by side.

A light source (more specifically, LED) 54 is further installed to the circuit board 5 to notify the user of the operating status of the shutter eyeglasses 1. The light source 54 is arranged next to the switch 53. A light source cover 18 is provided in the upper shield section 33 (more specifically, the outer wall section 33A of the front frame 3A) to cover the light source 54 as illustrated in FIG. 1. The same cover 18 is formed with a light transmitting material.

As illustrated in FIGS. 2 and 4, the front frame 3A has, at the horizontal center portion, a front wall section 31 adapted to define the front side of the space formed inside the bridge D. A hole 31a is formed in the front wall section 31. The hole 31a is located on the front side of the reception element 7. A synchronizing signal transmitted from the image display device 100 enters the reception element 7 through the hole 31a.

As has been described so far, all the electrical components (the circuit board 5 and installed components 51, 52, 53 and 54, battery 12 and reception element 7 described above) of the shutter eyeglasses 1 are arranged between the right and left shutters 2R and 2L. Therefore, no electric conductors are provided in the side shield sections 35, upper shield section 33 or lower bar section 37. As described above, the upper shield section 33 includes the outer wall section 33A of the front frame 3A and the inner wall section 33B of the rear frame 3B. In this example, no electric conductors are provided in the upper shield section 33. This makes it easy to form ribs 33a between the inner wall section 33B and outer wall section 33A making up the upper shield section 33 so as to secure the strength of the upper shield section 33, thus contributing to improved strength of the same section 33. As illustrated in FIG. 2, the ribs 33a are formed from the rear edge to the front edge of the inner wall section 33B. The plurality of ribs 33a are arranged horizontally side by side at equal intervals. Further, as described above, the side shield sections 35 includes the outer wall section 35A of the front frame 3A and the inner wall section 35B of the rear frame 3B. No components are arranged inside the outer wall section 35A and inner wall section 35B, making these sections hollow. This contributes to a reduced load on the user's ears when the shutter eyeglasses 1 are worn.

As illustrated in FIG. 4, the shutter eyeglasses 1 include a front cover 16 arranged on the front side of the circuit board 5 and battery 12. The same cover 16 is attached to the front face of the front wall section 31 provided at the center portion of the front frame 3A. The front cover 16 is shaped to fit the front wall section 31, closing the hole 31a formed on the front side of the reception element 7. The front cover 16 is formed with a light transmitting material so that light from the image display device 100 enters the reception element 7 through the front cover 16 and hole 31a.

As illustrated in FIG. 5, the front cover 16 is arranged to be flush with the right and left shutters 2R and 2L. That is, the right-side portion of the front cover 16 is approximately flush with the right eye shutter 2R, and the left-side portion of the front cover 16 is approximately flush with the left eye shutter 2L. This structure makes it less likely that an external force will act on the front wall section 31 forming the bridge D than the structure in which the front cover 16 is located more forward than the shutters 2R and 2L. This prevents a load from being exerted on the electrical components accommodated in the bridge D.

As illustrated in FIGS. 2 and 5, the rear frame 3B has inner wall sections 34 forming the side faces of the bridge D. Each of the inner wall sections 34 is formed along an inner edge 2a of one of the right and left shutters 2R and 2L. Front edges 34a of the inner wall sections 34 are located rearward of and in contact with the edges 2a of the shutters 2R and 2L. This structure restricts the rearward movement of the edges 2a, thus properly maintaining the positional relationship between the front cover 16 and the edges 2a of the shutters 2R and 2L. That is, the shutters 2R and 2L are maintained flush with the front cover 16.

As described above, the rear frame 3B has the flange section 38 that protrudes forward from the lower edge of the rear lower wall section 32. The front frame 3A has the front lower wall section 39 that is formed on the lower edge of the front wall section 31. The space inside the bridge D is formed as a closed space by the inner wall sections 34, rear lower wall section 32 and flange section 38 of the rear frame 3B, the front wall section 31 and front lower wall section 39 of the front frame 3A, and the rear cover 13. The components accommodated in the bridge D are protected by these wall sections, cover and flange section.

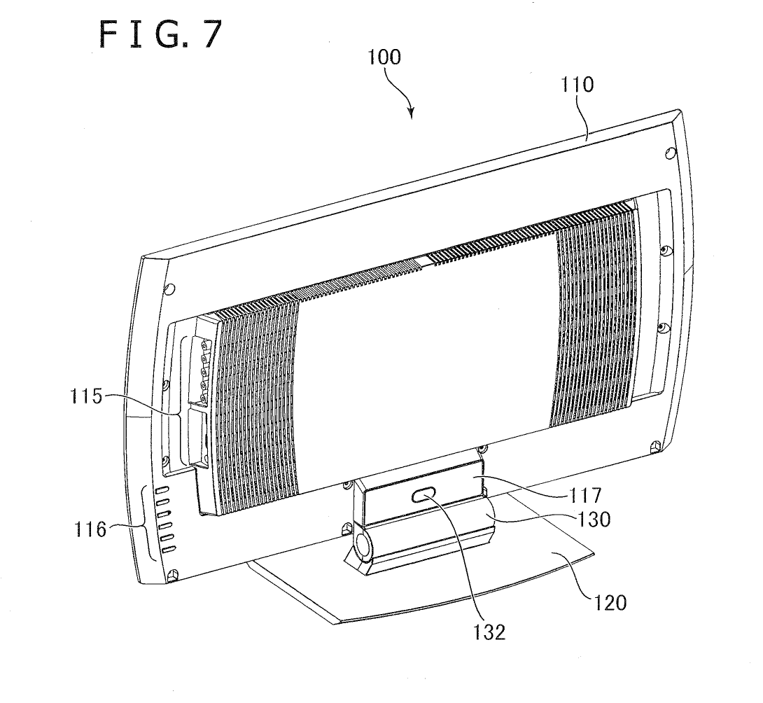

A description will be given here of the image display device 100. FIGS. 6 and 7 are perspective views illustrating the appearance of the image display device 100. FIG. 6 illustrates the image display device 100 as seen from the front, and FIG. 7 illustrates the same device 100 as seen from the rear. As illustrated in these figures, the image display device 100 includes a main body section 110, base 120 and support 130.

The main body section 110 is the main body of the image display device 100 and includes a display screen 111 adapted to display an image on the front face. Further, a status display indicator 112, power indicator 113 and speakers 114 adapted to play audio are arranged respectively at the bottom center, at the bottom left, and at the left and right of the display screen 111 on the front face of the main body section 110. The status display indicator 112 and power indicator 113 are used to show the operating status of the image display device 100.

A plurality of input/output terminals 115 are provided on the rear face of the main body section 110 to exchange signals with external equipment (e.g., home gaming machine). More specifically, the image display device 100 includes input terminals adapted to input image signals such as image signals compliant with the HDMI (High-Definition Multimedia Interface) standard and component image signal. Further, the same device 100 may include output terminals adapted to output audio or other signals to external equipment.

A plurality of operation buttons 116 including a power button are arranged on the rear face of the main body section 110. These operation buttons 116 are used, for example, to change various settings of the image display device 100 and adjust the display thereof.

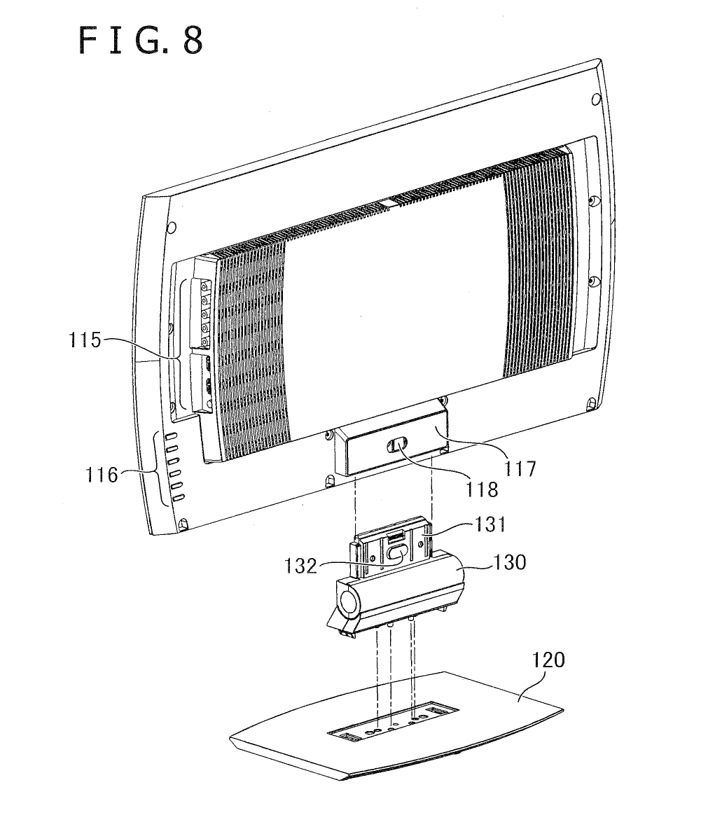

The main body section 110, base 120 and support 130 are detachable from each other. FIG. 8 is an exploded perspective view illustrating the connection relationship therebetween. The support 130 is screwed from the bottom of the base 120, thus fastening the support 130 to the base 120. Further, a hollow connection section 117 is arranged on the rear face of the main body section 110. A hole 118 is formed in the connection section 117. On the other hand, an insertion section 131 having a protruding portion 132 is arranged at the upper portion of the support 130. This protruding portion 132 can be pushed in and is biased in the direction of protrusion from the insertion section 131. When the insertion section 131 of the support 130 is inserted into the connection section 117, the protruding portion 132 engages with the hole 118, thus fastening the main body section 110 to the support 130. When the main body section 110 is raised upward while at the same time pushing in the protruding portion 132 with the main body section 110 fastened to the support 130, the main body section 110 can be removed from the support 130. As described above, the main body section 110 can be manually detached from or attached to the support 130 by the user with ease without using tools. Therefore, the user can, under certain circumstances, detach the main body section 110 from the support 130 and place the same section 110 at a desired location to view an image. It should be noted that, as illustrated in FIG. 7, the input/output terminals 115 are arranged on the side face of the main body section 110. Therefore, even if the main body section 110 is laid on a floor surface with the rear face of the same section 110 placed face down, cables can be connected to the input/output terminals 115. This allows the user to view an image even when the main body section 110 is laid on a floor surface in such a manner that the display screen 111 is oriented level.

Further, the image display device 100 supports the frame sequential stereoscopic display. That is, the same device 100 makes up a frame sequential image display system together with the shutter eyeglasses 1. More specifically, the image display device 100 switches alternately between right and left eye images in a time divided manner for display on the display screen 111. Further, a transmitter 119 is arranged in the main body section 110 to transmit a synchronizing signal adapted to notify an image switch timing to the appropriate shutter eyeglasses 1. In response to the synchronizing signal, the shutter eyeglasses 1 close the left eye shutter 2L while the right eye image is displayed on the display screen 111 and close the right eye shutter 2R while the left eye image is displayed on the display screen 111. This allows the user wearing the shutter eyeglasses 1 to view the left eye image with his or her left eye and the right eye image with his or her right eye.

Further, the image display device 100 allows a plurality of users to view different images using the frame sequential display technology. More specifically, the image display device 100 displays on the display screen 111 one image for a user A and another image for a user B alternately rather than right and left eye images. Further, the transmitter 119 transmits signals adapted to notify an image switch timing to each of the shutter eyeglasses 1 used by the users A and B. In response to the signals, the shutter eyeglasses 1 used by the user A close the shutters 2R and 2L for both eyes while the image for the user B is displayed, and opens the shutters 2R and 2L for both eyes while the image for the user A is displayed. Conversely, the shutter eyeglasses 1 used by the user B close the shutters 2R and 2L for both eyes while the image for the user A is displayed, and opens the shutters 2R and 2L for both eyes while the image for the user B is displayed. This allows the two users to view completely different images.

As described above, the circuit board 5, battery 12 and reception element 7 are arranged between the left and right eye shutters 2L and 2R in the shutter eyeglasses 1. This layout provides simpler wiring in the shutter eyeglasses 1.

Further, in the shutter eyeglasses 1, the battery 12 and circuit board 5 are longitudinally side by side. This layout makes it easier to strike a horizontal weight balance of the shutter eyeglasses 1.

Still further, in the shutter eyeglasses 1, the battery 12 is located rearward of the circuit board 5. This layout allows the battery 12, a component heavier than other components, to be located closer to the user when the shutter eyeglasses 1 are used, thus ensuring stability in supporting the shutter eyeglasses 1 with the nose and ears of the user.

In the shutter eyeglasses 1, the battery 12 is arranged above the nose pad 11. This layout allows the load of the battery 12 to act vertically on the user's nose via the noise pad 11, thus providing further improved stability in supporting the shutter eyeglasses 1.

Further, in the shutter eyeglasses 1, the front cover 16 is arranged on the front side of the circuit board 5, battery 12 and reception element 7 in such a manner as to be flush with the right and left shutters 2R and 2L. This structure makes it less likely that an external force will act on the front wall section 31 forming the bridge D than the structure in which the front cover 16 is located more forward than the shutters 2R and 2L. This prevents a load from being exerted on the circuit board 5 and other components accommodated in the bridge D.

Still further, in the shutter eyeglasses 1, the connector 52 to which electric conductors are connected to charge the battery 12 is also arranged between the left and right eye shutters 2L and 2R. This layout provides further simpler wiring in the shutter eyeglasses 1.

It should be noted that the present invention is not limited to the shutter eyeglasses 1 and may be modified in various ways.

For example, the battery 12 and circuit board 5 are longitudinally side by side in the above description. However, the layout of the battery 12 and circuit board 5 is not limited thereto. Instead, they may be arranged horizontally side by side.

Further, in the above description, the front cover 16 is arranged to be flush with the right and left shutters 2R and 2L. However, the front cover 16 may be arranged more forward than the right and left shutters 2R and 2L.

Still further, a primary battery maybe used as the battery 12. In this case, the connector 52 need not necessarily be provided. Further, in this case, the battery 12 may be replaced by removing the rear cover 13.

1. Shutter eyeglasses, comprising:
left and right eye shutters, each having normal vectors oriented in a longitudinal direction;
a circuit board having a drive circuit adapted to drive the left and right eye shutters such that the left and right eye shutters open and close in synchronism with images displayed on an image display device;
a battery adapted to supply power to the circuit board; and
a reception element adapted to receive a synchronizing signal from the image display device and provide a corresponding synchronizing signal to the circuit board;
wherein the circuit board, battery and reception element are arranged between the left and right eye shutters, and the circuit board and battery each have normal vectors that are coaxially aligned in the longitudinal direction.

2. The shutter eyeglasses of claim 1, wherein the battery and circuit board are arranged longitudinally side by side.

3. The shutter eyeglasses of claim 2, wherein the battery is arranged rearward of the circuit board.

4. The shutter eyeglasses of claim 1, further comprising:
a nose pad supported by the nose of the user when the shutter eyeglasses are used;
the battery being located above the nose pad.

5. The shutter eyeglasses of claim 1, further comprising:
a front cover arranged on the front side of the circuit board, battery and reception element;
the front cover being arranged to be flush with the right and left shutters.

6. The shutter eyeglasses of claim 1, further comprising: a connector arranged between the left and right eye shutters and to which electric conductors are connected to charge the battery.

7. The shutter eyeglasses of claim 1, further comprising a planar resilient element interposed between the battery and the circuit board such that respective opposing forces acting on, and urging the battery and the circuit board together, are transferred to the resilient element.

8. The shutter eyeglasses of claim 7, wherein the battery, drive circuit, and circuit board are of planar orientation, and are arranged in a layered configuration in the longitudinal direction.

9. The shutter eyeglasses of claim 8, further comprising:
a front frame element operating to provide one of the respective opposing forces directly or indirectly to the circuit board;
a rear frame element operating to provide the other of the respective opposing forces directly or indirectly to the battery; and
one or more intermediate frame elements directly or indirectly engaging the front and rear frame elements and operating to urge the front and rear frame elements toward one another, thereby producing the respective opposing forces, which urge the battery, the planar resilient element, the drive circuit, and the circuit board together.

10. The shutter eyeglasses of claim 1, further comprising:
a frame having left and right support sections operating to engage the respective left and right eye shutters, and a bridge section interposed between the left and right support sections,
wherein the bridge section of the frame defines an inner volume size and shaped to house the battery, the circuit board, and the reception element therein.

11. The shutter eyeglasses of claim 10, further comprising:
a nose pad disposed below the bridge section and operating to engage a bridge of a user's nose when the shutter eyeglasses are worn,
wherein the battery is located within the bridge section substantially directly above the nose pad such that a weight of the battery acts downwardly through the nose pad to the bridge of a user's nose.

12. The shutter eyeglasses of claim 11, wherein the circuit board and the reception element are disposed forward of the battery in the longitudinal direction.
